(19) United States
(12) Patent Application Publication
(10) Pub. No.: US 2026/0016600 A1
(43) Pub. Date: Jan. 15, 2026

(54) OPTOELECTRONIC SENSOR FOR DETECTING OBJECTS

(71) Applicant: BAUMER ELECTRIC AG, FRAUENFELD (CH)

(72) Inventors: MARIUS CLAD, GOTTLIEBEN (CH); HENRY LERCHNER, STETTFURT (CH)

(73) Assignee: BAUMER ELECTRIC AG, FRAUENFELD (CH)

(21) Appl. No.: 19/267,662

(22) Filed: Jul. 14, 2025

(30) Foreign Application Priority Data
Jul. 15, 2024 (DE) 10 2024 120 140.1

(51) Int. Cl. G01S 17/48; G01S 7/481

(52) U.S. Cl. CPC G01S 17/48; G01S 7/4813

(57) ABSTRACT

An optoelectronic sensor for detecting an object includes a light-transmitting element which transmits light signals onto a detection region, a light-receiving device which detects the light signals reflected from the object, a sensor housing, and a carrier unit with a circumferentially closed opening. The sensor unit, in a delivery state, forms an interior space for accommodating the light-transmitting element and the light-receiving device, and, in an operating state, has a receptacle for a fastening element which fixes the optoelectronic sensor to an external body. In the delivery state, the carrier unit is arranged in the interior space and accommodates and aligns the light-transmitting element and the light-receiving device. The receptacle is provided as a tube section which completely penetrates the interior space. In the operating state, the tube section is arranged within the closed opening to provide the fastening element in the tube section and thus within the closed opening.

### CROSS REFERENCE TO PRIOR APPLICATIONS

Priority is claimed to German Patent Application No. DE 10 2024 120 140.1, filed Jul. 15, 2024. The entire disclosure of said application is incorporated by reference herein.

### FIELD

The present invention relates to an optoelectronic sensor for detecting objects in a detection region.

### BACKGROUND

Optoelectronic sensors for detecting objects have previously been described.

The previously-described optoelectronic sensors transmit light signals along a transmitted-light path to a detection region.

The transmitted light signals are reflected by objects in the detection region. Some of the reflected light signals again hit the sensor. The sensor comprises a light detection device to detect the reflected light signals. This allows the presence of objects within the detection region to be detected. It has also previously been described to determine the angle of incidence of the reflected light signals in order to ascertain the distance of the object from the sensor.

Previously described optoelectronic sensors comprise a sensor housing for accommodating and aligning the light-transmitting element and the light-receiving device. The sensor housing comprises a receptacle in an edge section for accommodating a fastening element to fix the sensor to the external body and to align it with the detection region.

Although a sensor housing made of plastic can be manufactured more cost-effectively than a sensor housing made of metal, plastic has larger measurement tolerances because, due to the larger thermal coefficient of the plastic, the housing expands more when the temperature changes. This affects the relative position of the light-transmitting element and the light-receiving device, which has a negative effect on the measurement result.

### SUMMARY

An aspect of the present invention is to overcome the disadvantages of the prior art. An aspect of the present invention is in particular to provide an optoelectronic sensor in which a temperature change and the associated thermal expansion of the sensor housing do not have a negative effect on the measurement result of the optoelectronic sensor.

In an embodiment, the present invention provides an optoelectronic sensor for detecting at least one object in a detection region. The optoelectronic sensor comprises a light-transmitting element which is configured to transmit light signals along a transmitted-light path onto the detection region, a light-receiving device which is configured so that the light signals which are reflected from the at least one object in the detection region and which are propagated along a received-light path are detectable, a sensor housing, and a carrier unit comprising a circumferentially closed opening. In a delivery state, the sensor housing forms an interior space for accommodating the light-transmitting element and the light-receiving device. In an operating state, the sensor housing comprises a receptacle for a fastening element which is configured to fix the optoelectronic sensor to an external body. The carrier unit, in the delivery state, is arranged in the interior space and is configured to accommodate and align the light-transmitting element and the light-receiving device. The receptacle is provided as a sleeve-shaped tube section which is arranged to completely penetrate the interior space. In the operating state, the sleeve-shaped tube section is arranged within the circumferentially closed opening so as to arrange the fastening element in the sleeve-shaped tube section and thus within the circumferentially closed opening.

### BRIEF DESCRIPTION OF THE DRAWINGS

The present invention is described in greater detail below on the basis of embodiments and of the drawings in which:

FIG. 1 shows a schematic representation of an optoelectronic sensor according to the present invention according to a first embodiment in a plan view;

FIG. 2 shows a schematic representation of an optoelectronic sensor according to the present invention according to a second embodiment in a plan view;

FIG. 3 shows, in a highly schematic manner, the detection plane formed by the light-sensitive detection element of the optoelectronic sensor of FIG. 2;

FIG. 4 shows a schematic exploded view of a sensor housing and a carrier unit according to a third embodiment of the optoelectronic sensor according to the present invention;

FIG. 5 shows a first schematic representation of the optoelectronic sensor according to the present invention for close-range and long-range monitoring in an operating state; and

FIG. 6 shows a second schematic representation of the optoelectronic sensor according to the present invention for close-range and long-range monitoring in an operating state.

### DETAILED DESCRIPTION

The optoelectronic sensor according to the present invention is designed to detect objects in a detection region. The optoelectronic sensor according to the present invention can, for example, be a triangulation sensor.

The optoelectronic sensor according to the present invention comprises light-transmitting elements which are designed so that light signals can be transmitted along a transmitted-light path onto the detection region.

The optoelectronic sensor according to the present invention also comprises light-receiving devices which are designed so that light signals reflected from an object in the detection region and propagating along a received-light path can be detected and/or sensed.

The object to be detected can be located at different positions within the detection region. For the multitude of possible positions, an individual received-light path always results if the transmitted-light path remains constant and/or identical. It is further noted that the transmitted-light path differs from the received-light path and/or that the position of the light-transmitting element in the sensor housing differs from the position of the light-receiving device.

The optoelectronic sensor according to the present invention further comprises a sensor housing which forms an interior space for accommodating the light-transmitting element and the light-receiving device in a delivery state, wherein the sensor housing comprises a receptacle for a fastening element for fixing the optoelectronic sensor in an operating state to an external body.

The optoelectronic sensor according to the present invention further comprises a carrier unit which is, in the delivery state, arranged in the interior space of the sensor housing.

The carrier unit is designed so that the light-transmitting element and the light-receiving device are not only accommodated and held, but are also aligned and thus positioned relative to one another. The carrier unit is further designed so that the light-transmitting elements are aligned with and held at a distance from the light-receiving device. The distance, which is measured perpendicularly to the transmitted-light path, is referred to as the base distance in the context of the present invention.

In the optoelectronic sensor according to the present invention, it is also provided that the housing-side receptacle is designed as a sleeve-shaped tube section that completely penetrates the interior space and that the carrier unit comprise a circumferentially closed opening, wherein, in the operating state, the tube section is located within the opening. The fastening element, which is provided to fix the sensor to an external body, can thus be inserted into the cavity formed by the tube section and is thus arranged within the tube section and the opening.

The tube section according to the present invention completely penetrates and/or passes through the sensor housing, in particular with respect to a depth dimension of the sensor housing.

In other words, in the operating state, the tube section of the sensor housing is located within the opening of the carrier unit, and the fastening element is located within the tube section. In the operating state, the tube section is thus formed around the elongated fastening element, and the carrier unit is thus formed around the tube section. In other words, the free opening of the tube section is designed to accommodate the fastening element for fixing the optoelectronic sensor in the operating state to an external body.

The sensor housing, which comprises and/or forms the sleeve-shaped tube section, is in particular formed in one piece and/or monolithically.

The carrier unit, which comprises and/or forms the circumferentially closed opening is in particular formed in one piece and/or monolithically.

By inserting a fastening element, in particular an elongated fastening element, into the inner opening of the tube section, the tube section and thus the sensor housing, and the carrier unit and thus the light-transmitting element and the light receiving device, can be fixed to the external body so that thermal expansion of the sensor housing does not have a negative effect on the relative position of the light-transmitting and the light-receiving device.

The present invention thus provides a thermal decoupling between the sensor housing and the carrier unit since the sensor housing and the carrier unit are fixed to the external body by a common fastening point.

The advantage here is that a large thermal expansion coefficient of the sensor housing does not have a negative effect on the measurement result since the present invention provides a decoupling between the sensor housing and the carrier unit, and thus the relative position between the light-transmitting element and the light-receiving device, through the common fastening point.

The carrier unit is in particular designed so that thermal expansion does not have a negative effect on the positions of the light-transmitting and light-receiving device.

In a further development, the present invention provides that the tube section and/or the opening comprise(s) a substantially circular cross-section, wherein, in the delivery state, the tube section and the opening are formed coaxially with one another.

The circumferentially closed opening in the carrier unit is thus in particular designed as a bore. This advantageously reduces manufacturing costs since a bore is technically easy to implement.

The fastening element can, for example, be elongated. In other words, the sleeve-shaped tube section and/or the circumferentially closed opening is designed for inserting and accommodating an elongated fastening element.

A screw, a positioning pin, or a bolt can, for example be used as a fastening element.

The fastening element fixes the sensor to the external body. The free opening of the sleeve-shaped tube section according to the present invention, which can be positioned internally and/or radially inwards and/or directly adjacent to and/or directly adjoining the opening and/or the bore, can thus accommodate a screw or a positioning pin or a bolt, wherein the screw or the positioning pin or the bolt project into the external body at the end.

It is also noted that, in the operating state, the detection region extends laterally with respect to the longitudinal extent of the tube section. The orientation of the opening and/or the orientation of the tube section and/or the depth dimension of the sensor housing thus run substantially orthogonally to the plane spanned by the transmitted-light path and/or the received-light path.

In an embodiment of the optoelectronic sensor according to the present invention, the light-receiving device can, for example, comprise a converging lens for concentrating the light signals, propagated along the received-light path, onto a light-sensitive detection element, as well as the light-sensitive detection element. The converging lens is positioned and/or aligned in the carrier unit so that, in the side view of the sensor housing, a perpendicular to the transmitted-light path extends both through the optical center, in particular the center of mass, of the converging lens and substantially through the center of the receptacle.

The light-receiving device can, for example, comprise a plurality of lenses, in particular, a first and a second converging lens. The light-transmitting element can, for example, comprise an optical lens and/or a light source, in particular an LED or a laser source.

It can thus advantageously be prevented that the position of the converging lens shifts laterally and/or with respect to a width dimension of the sensor housing in the event of a thermal expansion of the carrier unit since thermal expansion of the carrier unit will have an effect, in particular, substantially along a height dimension of the sensor housing.

In other words, the straight line spanning from the center of mass of the converging lens to the center of the receptacle essentially does not change its distance from the object to be detected, or changes it only minimally, even in the event of thermal expansion of the sensor housing and/or the carrier unit.

In this connection, the present invention further provide that, in a further development, the light-sensitive detection element has a plurality of light-sensitive detection regions. The detection regions are arranged directly adjacent to one another and are positioned relative to the converging lens. The individually evaluable detection regions allow the angle of the received-light path relative to the transmitted-light path to be measured, thus determining the distance of the object from the sensor.

The optoelectronic sensor according to the present invention can thus advantageously be designed as a triangulation sensor.

In an embodiment of the present invention, the carrier unit is not only monolithic and/or formed in one piece, but can, for example, also be made of a ceramic or a metal, in particular of steel or aluminum. Due to their low thermal expansion coefficients, these materials are particularly suitable for designing the carrier unit according to the present invention.

In a further development of the present invention, the sensor housing can, for example, be made of a plastic. A sensor housing made of plastic can be manufactured at low cost and is not electrically conductive.

The sensor housing also comprises at least one entry and exit area for the light signals. The entry and exit area can, for example, be formed at least partially in a front side of the sensor housing by a window region. The entry and exit area and/or the window region can, for example, be formed by a transparent element, for example, by a transparent plastic or glass element, for example, by a filter element designed with regard for the wavelength of the light signals.

With regard to the filter element, it should be noted that the filter element is transparent only in the wavelength range of the generated light signals. Light of a different wavelength cannot penetrate the sensor housing.

In an embodiment of the present invention, the optical sensor can, for example, comprise a further receptacle for inserting a further fastening element to fix the optoelectronic sensor in the operating state to the external body and thus to align the detection region with the region to be monitored.

In connection therewith, the present invention further provides that, in a further development, the further receptacle be formed in the side view of the sensor housing in a region of the sensor housing that extends within the sensor housing and, with respect to the propagation direction of the reflected light signals, behind the light-receiving device. The further receptacle is in particular formed at least in part within the interior space and/or penetrates the interior space at least partially and/or in some regions.

In connection therewith, the present invention further provide that, in a further development, the further receptacle be designed as a sleeve-shaped tube section that completely penetrates the interior space and/or is directly adjacent to the interior space. In other words, the additional receptacle, which is designed as a sleeve-shaped tube section, completely penetrates the interior space in terms of the depth dimension of the sensor housing.

In connection therewith, a further development of the present invention provides that the further receptacle can, for example, be designed to be elastic and/or resilient so that the sensor housing between the first and the further receptacles is designed to be flexible and/or variable with respect to the length of the sensor housing between the two receptacles to compensate for thermally induced stresses between the sensor housing and the external body.

The expansion of the sensor housing during a temperature change can thus be specifically influenced so that it has an effect starting from the first receptacle in the direction of the further receptacle.

However, the second receptacle shows the least possible flexibility in the direction orthogonal to the plane spanned by the two receptacles, wherein the plane is spanned by the respective central axis of the two receptacles.

A negative influence on the measurement result due to tension and/or rotation around the first receptacle of the sensor housing with a negative effect on the light-transmitting and light-receiving device can thus advantageously be avoided.

In connection therewith, the present invention further provides that, in a further development, the further receptacle be formed by an inner and an outer sleeve element, wherein the inner and the outer sleeve elements are coaxially aligned with one another and are spaced apart from one another by web elements so that the sensor housing can expand along the distance between the receptacle and the further receptacle due to a free space formed between the web elements, and wherein the inner sleeve element is designed to accommodate the fastening element.

The present invention is explained in greater detail below by way of example with reference to the drawings. The combination of features shown as examples in the embodiments can, in accordance with the above statements, be supplemented by further features according to the properties of the subject matter of the present invention required for a specific application. In accordance with the above statements, individual features may also be omitted from the described embodiments if the effect of this feature is not important in a specific application.

In the drawings, elements with the same function and/or structure are designated by the same reference character.

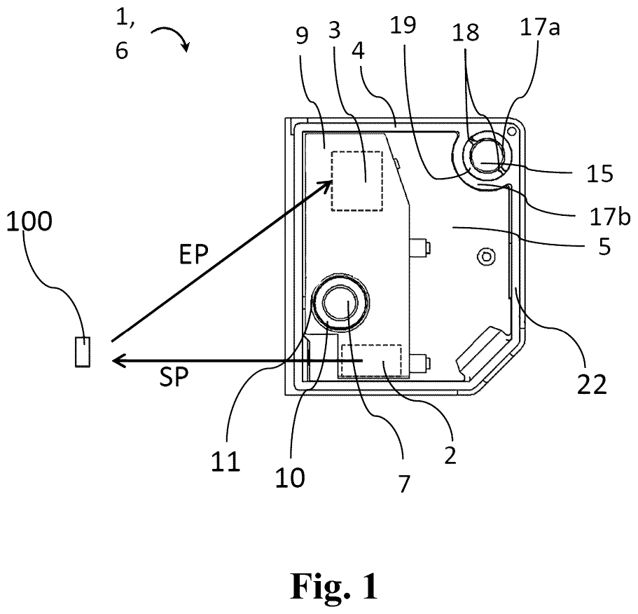

FIG. 1 shows a side view of an embodiment of the optoelectronic sensor 1 according to the present invention in a delivery state 6, wherein the sensor 1 is designed to detect objects 100 in a detection region.

The sensor 1 according to the present invention comprises a light-transmitting element 2. The light-transmitting element 2 according to the present invention is designed to transmit light signals. The light signals propagate along a transmitted-light path SP to the detection region to detect an object 100 located within the detection region.

In the event that an object 100 is located in the detection region, the light signals are reflected and/or remitted by the object 100. Some of these light signals thus again impinge on the sensor 1.

The sensor 1 according to the present invention further comprises a light-receiving device 3 for detecting the reflected light signals which propagate along a received-light path EP from the object 100 in the direction of the sensor 1.

The sensor 1 according to the present invention further comprises a sensor housing 4. The sensor housing 4 according to the present invention comprises a wall 22 and thus encloses an interior space 5 for accommodating a carrier unit 9. The carrier unit 9 receives the light-transmitting element 2 and the light-receiving device 3 and aligns them with one another.

The sensor 1 further comprises a first receptacle 7 which is designed for inserting and accommodating a fastening element 102 (not shown) to fix the sensor 1 according to the present invention in an operating state 8 to an external body 101 and to align the detection region with a region to be monitored.

The sensor housing 4 comprises a sleeve-shaped tube section 10 which completely penetrates the sensor housing 4 in the region of the interior space 5 with respect to a depth dimension TE extending into the plane of the drawing.

The sleeve-shaped tube section 10 is spaced from the wall 22 of the sensor housing 4 and/or formed by separate housing elements.

In the present exemplary embodiment, the sleeve-shaped tube section 10 comprises an inner and an outer round cross-section. The inner diameter, which is formed as a through-hole, is adapted to accommodate an elongated fastening element in the form of a screw or a bolt.

The carrier unit 9 according to the present invention further comprises a circumferentially closed opening 11 which, in a delivery state 6 of the sensor 1, is arranged directly adjacent to the sleeve-shaped tube section 10.

The circumferentially closed opening 11 is provided by a bore in the present exemplary embodiment.

The inner surface of the circumferentially closed opening 11 and/or the outer surface of the bore of the carrier unit 9 and the outer surface and/or lateral surface of the sleeve-shaped tube section 10 are, in the delivery state 6, arranged directly adjacent to one another and/or mechanically contacted, which is shown in FIG. 1. In other words, the circumferentially closed opening 11 and the sleeve-shaped tube section 10 substantially form a positive connection that fixes all degrees of freedom and/or axes of movement except for one rotational degree of freedom. In order to avoid a relative movement between the sensor housing 4 and the carrier unit 9 with respect to the depth dimension TE of the sensor housing 4, which extends perpendicularly to the plane of FIG. 1, an additional securing measure is carried out, in particular, via a securing element (which not shown in detail), in particular, a nut or a screw interacting with the sleeve-shaped tube section 10. It is alternatively in particular also provided that the carrier unit 9 be fixed to the sensor housing 4 via adhesives. Each fixation can, for example, be provided close to the common fixation point of the sensor housing 4 and the carrier unit 9.

The carrier unit 9 consists of a metal and is monolithic in the present exemplary embodiment.

FIG. 1 also shows that the sensor 1 according to the present invention comprises a further receptacle 15 for accommodating a further fastening element. The sensor 1 can thus be fixed to an external body via the first receptacle 7 and the further receptacle 15.

The further receptacle 15 is designed to be flexible with respect to a thermal expansion of the sensor housing 4. This is in particular provided in the present exemplary embodiment in that the further receptacle 15 is formed by an inner sleeve element 17a and an outer sleeve element 17b.

The inner sleeve element 17a and the outer sleeve element 17b comprise a round cross-section with different diameters.

The inner sleeve element 17a and the outer sleeve element 17b are coaxially aligned with one another and are spaced apart from one another via web elements 18 so that, in the region of the further receptacle 15 and at the end of the section between the first receptacle 7 and the further receptacle 15, a free space 19 is formed between the web elements 18 and the opposite, free lateral surfaces of the two sleeve elements 17a, 17b, so that the sensor housing 4 can expand along the section through the free space 19 to compensate for thermally induced stresses.

The thermal expansion of the sensor housing 4 can thus specifically develop in such a way that the measurement result of the sensor 1 is not negatively influenced.

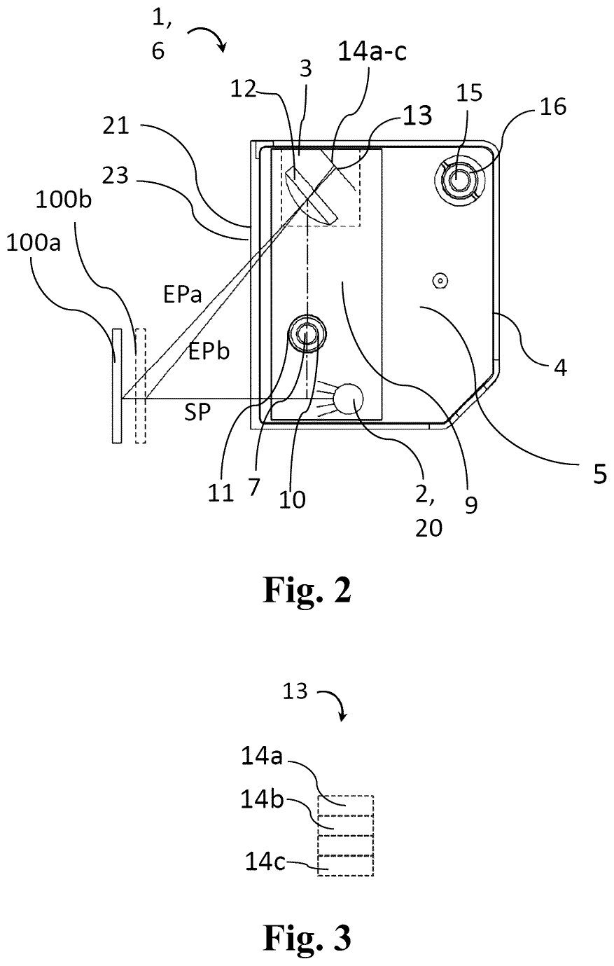

FIG. 2 shows an optoelectronic sensor 1 according to the present invention in the delivery state 6 according to a second embodiment.

According to the first exemplary embodiment, the sensor 1 comprises a sensor housing 4, wherein the first receptacle 7 is formed by a sleeve-shaped tube section 10 with a round cross-section.

The light-transmitting element 2 of the optoelectronic sensor 1 according to the second embodiment is provided by a laser source 20. The laser source 20 transmits light signals onto the detection region, which extends in a left-hand region of the FIG. 2 plane in the top view of the sensor 1 shown in the drawing.

The laser source 20 is received together with the light-receiving device 3 by a carrier unit 9 according to the present invention.

The monolithic carrier unit 9, which is made of a ceramic material with a low thermal expansion coefficient, extends in a front portion of the interior space 5 formed by the sensor housing 4. The carrier unit 9 further comprises a circumferentially closed opening 11 which, in the present embodiment, comprises a round cross-section, for forming the first receptacle 7.

The circumferentially closed opening 11 is dimensioned so that the sleeve-shaped tube section 10 can be snugly accommodated by the circumferentially closed opening 11. The sleeve-shaped tube section 10 is further dimensioned so that a fastening element 102, in particular a screw, can be snugly accommodated.

The light signals penetrate the sensor housing 4 within a window region 23 at a front side 21 of the sensor housing 4. The window region 23 is made of a transparent material to allow the light signals to pass through.

The light-receiving device 3 of the sensor 1 according to the second embodiment comprises a converging lens 12 which is arranged in all received-light paths EPa, EPb, so that light signals which have been reflected by an object and impinge on the converging lens 12 are bundled onto a light-sensitive detection element 13. The light-sensitive detection element 13 is configured to generate at least one measurement signal as a function of the intensity of the incident light signals.

The light-sensitive detection element 13 in the present embodiment comprises a plurality of light-sensitive detection regions 14a-14c which are in each case designed to detect incident light signals. The plurality of light-sensitive detection regions 14a-14c are arranged directly adjacent to one another and extend in a detection plane (see also in this regard a highly schematic plan view of the detection plane of the present detection element according to FIG. 3).

The individual evaluation of the light-sensitive detection regions 14a-14c makes it possible to determine the orientation of the received-light path with respect to the transmitted-light path. The distance of an object 100a, 100b from the sensor 1 can thus be determined.

FIG. 2 shows that two objects 100a, 100b to be detected are positioned at different positions in the detection region of the sensor 1 according to the present invention.

From the sketched courses of the light signals, it can be seen that, for the two objects 100a, 100b, an identical transmitted-light path SP results in an individual received-light paths EPa, EPb. The light signals of both individual received-light paths EPa, EPb impinge upon the converging lens 12 and lead to a change in the relative intensity distribution of the light-sensitive detection regions 14a, 14b, which can be measured.

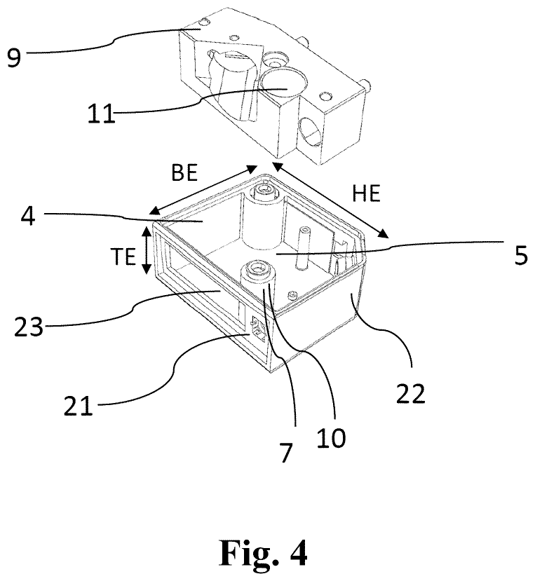

The sensor 1 according to the second embodiment also comprises a further receptacle 15. The further receptacle 15 in the present embodiment is formed by a further sleeve-shaped tube section 16, with a round cross-section, which completely penetrates the sensor housing 4 in the region of the interior space 5 with respect to the depth dimension TE (compare FIG. 4) of the sensor 1.

The further sleeve-shaped tube section 16 is located in a region of the sensor housing 4 behind the carrier unit 9.

The further sleeve-shaped tube section 16 is further located in a region of the interior space 5 into which the carrier unit 9 does not extend. In other words, the carrier unit 9 according to the present invention is in operative contact only with the (first) sleeve-shaped tube section 10.

FIG. 3 shows, in a highly schematic manner, the detection plane formed by the light-sensitive detection element 13 which is formed by the plurality of light-sensitive detection regions 14a-14c. The light-sensitive detection regions 14a-14c are arranged directly adjacent to one another and can vary greatly in number.

FIG. 4 shows the sensor housing 4 and the carrier unit 9 of an optoelectronic sensor 1 according to the present invention according to a further embodiment, slightly modified with respect to the embodiments already described, in an exploded view.

The sensor housing 4 is formed by the wall 22, which encloses and/or defines the interior space 5.

It can also be seen that the sleeve-shaped tube section 10, which forms the first receptacle 7 for accommodating the fastening element, is a free-standing component in the region of the interior space 5 and is thus spaced apart from the wall 22 which encloses and/or defines the interior space 5.

It can also be seen that the sensor housing 4 comprises an opening on the front side 21 for forming the window region 23. In the delivery state and/or operating state, the opening is covered by a transparent element that allows the light signals to pass through.

It can be seen that the sensor housing 4 comprises a lateral mounting opening 24 which is oriented upwards and which can be closed by a covering element (with is not shown) that forms the complete housing side of the sensor 1.

It is now also apparent from FIG. 4 that the carrier unit 9 according to the present invention comprises recesses for accommodating the light-transmitting element 2 and the light-receiving device 3 (which is not shown). A recess for accommodating a converging lens for focusing the light signals onto the light-sensitive element is also shown.

FIG. 4 also shows the circumferentially closed opening 11 which is dimensioned so that the sleeve-shaped tube section 10 formed as a separate component in the interior space 5 can be inserted into the circumferentially closed opening 11 and thus positioned there.

The circumferentially closed opening 11 of the carrier unit 9 is designed as a bore with a round cross-section. The diameter of the bore is selected so that, in the delivery state of the sensor 1, the sleeve-shaped tube section 10 fits snugly into the circumferentially closed opening 11. Both the carrier unit 9 and the sensor housing 4 can advantageously be fixed via a fastening element.

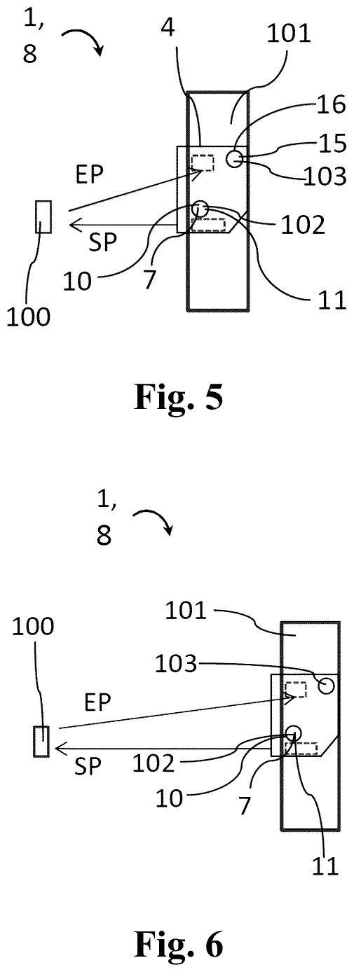

It is here also pointed out that the carrier unit 9 can be realized by a series of carrier units 9, each with a different position and/or orientation of the light-receiving device 3. The various carrier units 9 in particular differ in the orientation of the converging lens 12 comprised by the light-receiving device 3. An optoelectronic sensor 1 according to the present invention can thus advantageously be optimized either for the near range (see in particular FIG. 5) or for the far range (see in particular FIG. 6).

FIG. 4 also shows the orientation of the dimensional measurements of the sensor housing 4 (and thus of the sensor 1 according to the present invention) which is composed of the depth dimension TE, the height dimension HE, and the width dimension BE.

FIGS. 5 and 6 show two different embodiments of the optoelectronic sensor 1 according to the present invention, each in an operating state 8.

In the operating state 8, the optoelectronic sensor 1 according to the present invention is fixed to an external body 101 by two fastening elements 102, 103 so that the detection region of the sensor 1 is aligned with the region to be monitored.

This in particular means that a first fastening element 102 is arranged in the sleeve-shaped tube section 10, and thus fixes the sensor 1 to the external body 101. A further fastening element 103 is arranged in the further receptacle 15, wherein the further receptacle 15 is here also formed by a further sleeve-shaped tube section 16.

The exemplary embodiment of the optoelectronic sensor 1 according to FIG. 5 is designed for close-range monitoring, and the exemplary embodiment of the optoelectronic sensor 1 according to FIG. 6 is designed for long-range monitoring.

This is realized by two different carrier units 9, which are configured either to receive light signals under a large angular range between the transmitted-light path SP and the received-light path EP to realize short-range monitoring, or under a small angular range between the transmitted-light path SE and the received-light path EP to realize long-range monitoring.

The sensor 1 according to the present invention can thus advantageously be easily adapted to different applications, wherein the components do not differ from one another except for the carrier unit 9.

The present invention is not limited to embodiments described herein; reference should be had to the appended claims. The scope of the present invention thereby includes all combinations of at least two of the features disclosed in the description, the claims, and/or the drawings.

### LIST OF REFERENCE CHARACTERS

1 Sensor
2 Light-transmitting element
3 Light-receiving device
4 Sensor housing
5 Interior space
6 Delivery state
7 First receptacle
8 Operating state
9 Carrier unit
10 Sleeve-shaped tube section
11 Circumferentially closed opening
12 Converging lens
13 Light-sensitive detection element
14a Light-sensitive detection region
14b Light-sensitive detection region
14c Light-sensitive detection region
15 Further receptacle
16 Further sleeve-shaped tube section
17a Inner sleeve element
17b Outer sleeve element
18 Web element
19 Free space
20 Laser source
21 Front side
22 Wall
23 Window region
100 Object
100a Object
100b Object
101 External body
102 Fastening element
103 Further fastening element
BE Width dimension
EP Received-light path
EPa Individual received-light path
EPb Individual received-light path
HE Height dimension
SP Transmitted-light path
TE Depth dimension

What is claimed is:

1. An optoelectronic sensor for detecting at least one object in a detection region, the optoelectronic sensor comprising:
a light-transmitting element which is configured to transmit light signals along a transmitted-light path onto the detection region;
a light-receiving device which is configured so that the light signals which are reflected from the at least one object in the detection region and which are propagated along a received-light path are detectable;
a sensor housing which,
in a delivery state, forms an interior space for accommodating the light-transmitting element and the light-receiving device, and
in an operating state, comprises a receptacle for a fastening element which is configured to fix the optoelectronic sensor to an external body; and
a carrier unit comprising a circumferentially closed opening, the carrier unit, in the delivery state, being arranged in the interior space and being configured to accommodate and align the light-transmitting element and the light-receiving device,
wherein,
the receptacle is provided as a sleeve-shaped tube section which is arranged to completely penetrate the interior space, and
in the operating state, the sleeve-shaped tube section is arranged within the circumferentially closed opening so as to arrange the fastening element in the sleeve-shaped tube section and thus within the circumferentially closed opening.

2. The optoelectronic sensor as recited in claim 1, wherein the optoelectronic sensor is a triangulation sensor.

3. The optoelectronic sensor as recited in claim 1, wherein,
at least one of the sleeve-shaped tube section and the circumferentially closed opening comprises a substantially circular cross-section, and
in the delivery state, the sleeve-shaped tube section and the circumferentially closed opening are coaxial with one another.

4. The optoelectronic sensor as recited in claim 1, wherein,
the light-receiving device comprises a light-sensitive detection element and a converging lens, the converging lens being configured to bundle the light signals propagated along the received-light path onto the light-sensitive detection element, and
the converging lens is at least one of positioned and aligned in the carrier unit so that, in a side view of the sensor housing, a perpendicular to the transmitted-light path extends both through an optical center of the converging lens and substantially through a center of the receptacle.

5. The optoelectronic sensor as recited in claim 4 wherein the perpendicular to the transmitted-light path extends both through a center of mass of the converging lens and substantially through the center of the receptacle.

6. The optoelectronic sensor as recited in claim 4, wherein,
the light-sensitive detection element further comprises a plurality of light-sensitive detection regions which are arranged directly adjacent to one another, and
the plurality of light-sensitive detection regions are configured to detect an orientation of the received-light path relative to the transmitted-light path and to thus determine a distance of the at least one object from the optoelectronic sensor.

7. The optoelectronic sensor as recited in claim 1, wherein,
the carrier unit at least one of monolithic and integral, and/or
the carrier unit is made of a ceramic or a metal, and/or
the sensor housing is made of a plastic.

8. The optoelectronic sensor as recited in claim 7, wherein the metal is a steel or an aluminum.

9. The optoelectronic sensor as recited in claim 1, further comprising:
a further fastening element; and
a further receptacle which is configured to have the further fastening element be inserted therein so as to fix the optoelectronic sensor in the operating state to the external body and to thereby align the detection region with a region to be monitored.

10. The optoelectronic sensor as recited in claim 9, wherein, in a side view of the sensor housing, the further receptacle is arranged in a region of the sensor housing, with respect to a course of the light signals, along the received-light path behind the light-receiving device.

11. The optoelectronic sensor as recited in claim 9, wherein the further receptacle is provided as a further sleeve-shaped tube section which is arranged at least one of to completely penetrate the interior space and directly adjacent to the interior space.

12. The optoelectronic sensor as recited in claim 9, wherein the further receptacle is provided to be at least one of elastic and resilient so that the sensor housing is flexible between the receptacle and the further receptacle to compensate for thermally induced stresses between the sensor housing and the external body.

13. The optoelectronic sensor as recited in claim 9, wherein,
the further receptacle comprises an inner sleeve element, an outer sleeve element, and web elements,
a free intermediate space is arranged between the web elements,
the inner sleeve element and the outer sleeve element are aligned coaxially with one another and are spaced from one another via the web elements so that the sensor housing can expand along a distance between the receptacle and the further receptacle due to the free intermediate space which is arranged between the web elements, and
the inner sleeve element is configured to accommodate the further fastening element.
